(19) United States
(12) Patent Application Publication
(10) Pub. No.: US 2024/0013220 A1
(43) Pub. Date: Jan. 11, 2024

(54) EMBEDDING ANALYSIS FOR ENTITY CLASSIFICATION DETECTION

(71) Applicant: Capital One Services, LLC, McLean, VA (US)

(72) Inventor: Victoria MARTINS, Alameda, CA (US)

(73) Assignee: Capital One Services, LLC, McLean, VA (US)

(21) Appl. No.: 17/857,833

(22) Filed: Jul. 5, 2022

(51) Int. Cl. G06Q 20/40; G06F 21/31

(52) U.S. Cl. CPC G06Q 20/4016; G06F 21/31; G06F 2221/2111

(57) ABSTRACT

A first entity and a classification for the first entity may be identified based on historical data, and a second entity and a classification for the second entity may be identified based on current data. An embedding for a first stored entity may be assigned to the first entity based on a match between the first entity and the first stored entity, and an embedding for a second stored entity may be assigned to the second entity based on a match between the second entity and the second stored entity. A similarity value for the first and second entities may be generated based on the embedding for the first entity being a seed for a nearest-neighbor search. The classification for the second entity may be classified as the classification for the first entity when the similarity value satisfies a threshold, and interaction with the second entity may be restricted based on the classification.

### BACKGROUND

Networks (e.g., private networks, public networks, business enterprise networks, financial networks, etc.) and/or systems routinely experience malicious attacks by nefarious actors (e.g., devices, systems, users, etc.). Routinely, malicious attacks aim to obtain sensitive information and use the sensitive information for nefarious activities, for example, user impersonation, transaction fraud, currency laundering, and/or the like. Malicious attacks may include identity spoofing, for example, where a nefarious actor impersonates an entity in an attempt to interact (e.g., access, transact, communicate, etc.) with a user, a device, a network, a system, and/or the like to access sensitive information and/or resources. Conventional systems are unable to identify and classify nefarious actors as such before and/or during a malicious attack and may only identify the malicious attacks after they have been executed (if at all).

### SUMMARY

According to some aspects of this disclosure, a computing device (e.g., an application server, etc.) may identify a first entity and the classification for the first entity based on historical data, and identify a second entity and a classification for the second entity based on current data. An embedding for a first stored entity may be assigned to the first entity based on a match between the first entity and the first stored entity, and an embedding for a second stored entity may be assigned to the second entity based on a match between the second entity and the second stored entity. A similarity value for the first and second entities may be generated based on the embedding for the first entity being a seed for a nearest-neighbor search. The classification for the second entity may be classified as the classification for the first entity when the similarity value satisfies a threshold, and interaction with the second entity may be restricted based on the classification.

According to some aspects of this disclosure, the historical data may also indicate a third entity, a classification for the third entity, and a geofence for the third entity. The computing device may determine the geofence for the third entity based on the historical data and determine a user device attempting an interaction with the third entity at a location outside of the geofence based on the current data. The interaction with the third entity at the location outside of the geofence may be restricted and the classification for the third entity may be classified as the classification for the first entity based on the restriction.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example system for embedding analysis for entity classification, according to some aspects of this disclosure.

FIG. 2 illustrates operations performed for embedding analysis for entity classification, according to some aspects of this disclosure.

FIG. 3 illustrates a node representation of similar entities that may be used with embedding analysis for entity classification, according to some aspects of this disclosure.

FIG. 4 illustrates an example process flow for a predictive model trained for embedding analysis for entity classification, according to some aspects of this disclosure.

FIG. 5 illustrates a node representation of entities and classification based on identified similarities between the entities, according to some aspects of this disclosure.

FIG. 6 illustrates a flowchart of an example method for embedding analysis for entity classification, according to some aspects of this disclosure.

FIG. 7 illustrates a flowchart of an example method for embedding analysis for entity classification, according to some aspects of this disclosure.

FIG. 8 illustrates a flowchart of an example method for embedding analysis for entity classification, according to some aspects of this disclosure.

FIG. 9 illustrates a flowchart of an example method for embedding analysis for entity classification, according to some aspects of this disclosure.

FIG. 10 illustrates a flowchart of an example method for embedding analysis for entity classification, according to some aspects of this disclosure.

FIG. 11 illustrates an example computer system useful for implementing various aspects disclosed herein.

In the figures (drawings), like reference numbers generally indicate identical or similar elements. Additionally, generally, the left-most digit(s) of a reference number identifies the drawing in which the reference number first appears.

### DETAILED DESCRIPTION

The systems, methods, and computer program products described herein enable and/or facilitate embedding analysis for entity classification. Entity (e.g., device, system, user, etc.) interactions (e.g., transactions, communications, engagements, exchanges of information, etc.) may be modeled as a graph (e.g., a heterogeneous graph, of interaction participants where entities are connected by edges the represent the interactions.

For example, communications between user devices, networks, systems, and/or the like may be modeled as a heterogeneous graph of communications between user devices, networks, systems, and/or the like. Interactions (e.g., data exchanges, signaling, telemetry communications) between user devices, network devices, computing devices, and/or any other entities may be modeled as a heterogeneous graph of interactions between user devices, network devices, computing devices, and/or the like. Transactions (e.g., exchanges of funds, payments, purchases, offers, etc.) between merchants, customers, lenders, banks, and/or any other entities may be modeled as a heterogeneous graph of interactions between merchants, customers, lenders, banks, and/or the like.

Graphs of interactions between entities may be used for scenario analysis and situation modeling, for example, by a predictive model and/or the like. For example, graphs of interactions between entities may be used to determine and/or identify malicious attacks by nefarious actors (e.g., entities, devices, systems, users, etc.) such as user impersonations, transaction fraud, currency laundering, and/or the like. According to some aspects, formulation of a graph of interactions between entities and analysis of embeddings determined to be associated with the entities may increase the accuracy and speed of the nefarious action detection.

The systems, methods, and computer program products described herein enable and/or facilitate embedding analysis for entity classification to overcome challenges with conventional systems and/or graph embedding techniques that utilize highly dimensional (e.g., with tens or hundreds of millions of vertices) graphs and/or sparse (with each vertex interacting with a fraction of other vertices) graphs. Highly dimensional and/or sparse graphs are not suitable for machine learning models which routinely required defined datasets for training and predictive analysis. However, graphs based on interactions are rich datasets that should be able to be used to train a predictive model to identify and/or predict outlier activity in a data space. For example, graphs based on financial transactions and/or the like can be useful in detecting and predicting abnormal activities such as fraud, money laundering, credit risk, and/or the like. The systems, methods, and computer program products described herein enable and/or facilitate embedding analysis for entity classification utilizing graph embeddings to identify and/or predict outlier activity in a data space. For example, The systems, methods, and computer program products described herein enable and/or facilitate embedding analysis for entity classification utilize graph embeddings derived from financial transactions to predict and prevent fraud in real-time applications. The systems, methods, and computer program products described herein enable and/or facilitate embedding analysis for entity classification may be used for downstream tasks, for example, malicious attempts to access sensitive data, fraud detection, and/or the like, and may facilitate automatic defensive tactics based on detected fraudulent activity. These and other advantages are described herein.

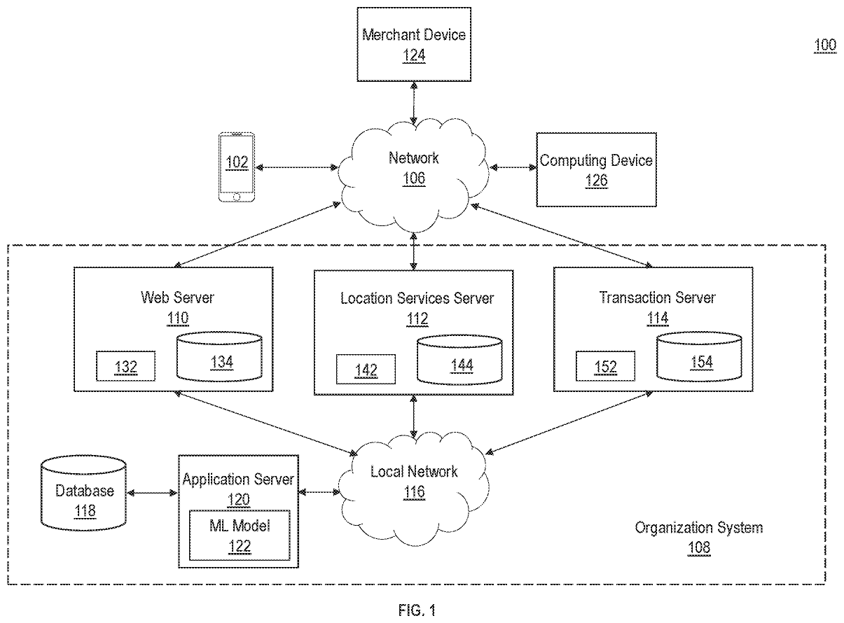

FIG. 1 is a block diagram of an example system 100 for embedding analysis for entity classification. According to some aspects of this disclosure, system 100 may perform one or more processes to enable the detection of outlier activities in a data space, for example, such as fraudulent or abnormal activities associated with user accounts (e.g., accounts associated with customers of an organization, etc.). According to some aspects of this disclosure, system 100, as described herein, facilitates network transactional monitoring and authorization for users (e.g., consumers, etc.) and/or user devices to engage in purchase activities while reducing the computational bandwidth and detection time typically associated with processing large volumes of data, for example, data associated with malicious and/or fraudulent activities. For example, by generating a specific data set labeling mechanism used to seed a nearest neighbor search (e.g., generating a default dataset to which all subsequent searches, calculations, and searches are compared, etc.) of embeddings, a system (e.g., the system 100, etc.) can accurately and expediently detect fraudulent merchant (or any other entity) activities within a network. According to some aspects, system 100 may accurately and expediently detect fraudulent merchant (or any other entity) activities in a manner that ensures quality control and uniformity in prediction results. According to some aspects, system 100 and/or the methodologies described herein enable an organizational system to predict, in advance, the likelihood of fraudulent activity associated with a suspected merchant and take measures to shield the organization and the consumer. While the foregoing description highlights examples related to fraud detection of financial transactions, it can be appreciated that other applications may be contemplated, including, for example, label propagation, outlier detection, and entity resolution.

According to some aspects of this disclosure, the system 100 may include a user device 102, a merchant device 124, a computing device 126, a network 106, and an organization system 108. According to some aspects, the organization system 108 may include, for example, a web server 110, a location services server 112, a transaction server 114, a local network 116, an application server 120, and a database 118. The back-end infrastructure web server 110, the location services server 112, the transaction server 114, the local network 116, the application server 120, and the database 118 may represent and/or be part of a back-end infrastructure of the organization system 108.

According to some aspects of this disclosure, network 106 may include a packet-switched network (e.g., internet protocol-based network), a non-packet switched network (e.g., quadrature amplitude modulation-based network), and/or the like. Network 106 may include network adapters, switches, routers, modems, and the like connected through wireless links (e.g., radiofrequency, satellite) and/or physical links (e.g., fiber optic cable, coaxial cable, Ethernet cable, or a combination thereof). Network 106 may include public networks, private networks, wide area networks (e.g., Internet), local area networks, and/or the like. Network 106 may include a content access network, content distribution network, and/or the like. Network 106 may facilitate communication between terminals, services, and devices and/or the like, for example, via radio-frequency identification (RFID), near-field communication (NFC), Bluetooth™, low-energy Bluetooth™ (BLE), WiFi™, ZigBee™, ambient backscatter communications (ABC) protocols, USB, or LAN. Network 106 may provide and/or support communication from telephone, cellular, modem, and/or other electronic devices to and throughout the system 100. Because the information transmitted may be personal or confidential, security concerns may dictate one or more of these types of connections be encrypted or otherwise secured.

According to some aspects of this disclosure, the user device 102 (may include, for example, a mobile device, a smart device, a laptop, a tablet, a display device, a computing device, or any other device capable of communicating with devices, systems, and/or components of the system 100. For example, the user device 104 may include a communication module (not shown) that facilitates and/or enables communication with the network 106 (e.g., devices, components, and/or systems of the network 106, etc.), the merchant device 124, the computing device 126, and/or any other device, system, and/or component of the system 100. For example, the communication module of the user device 102 may include hardware and/or software to facilitate communication. The communication module of the user device 102 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. The communication module of the user device 102 may include any hardware and/or software necessary to facilitate communication.

According to some aspects of this disclosure, the user device 102 may include one or more sensors for obtaining product data associated with a product the user may wish to purchase, such as a microphone, a digital camera, a geographic location sensor for determining the location of the device, an input/output device such as a transceiver for sending and receiving data, a display for displaying digital images and enabling web browsing, one or more processors including an authentication processor, and a memory in communication with the one or more processors.

According to some aspects of this disclosure, users of the user device 102 may include, for example, subscribers, clients, prospective clients, and/or holders of accounts services by organization system 108. For example, a user of the user device 102 may include individuals who have obtained, will obtain, or may obtain a product, a service, and/or a consultation from the organization system 108.

According to some aspects of this disclosure, the user device 102 may be in communication with a merchant device 124. For simplicity, merchant device 124 is shown as a single device. However, it is recognized that the merchant device 124 may represent a merchant point-of-sales (POS) device, a merchant system and/or network of devices, a merchant interface and/or application, a merchant terminal, and/or the like. According to some aspects of this disclosure, a user, for example, using the user device 102, may communicate and/or transact with a merchant via the merchant device 124. For example, the merchant device 124 may support and/or facilitate transactions at a physical location (e.g., merchant location, etc.), online via a website, and/or via an application configured with the merchant device 124 and/o the user device 102.

According to some aspects of this disclosure, the computing device 126 may include a server, cloud-based device, third-party system, and/or the like that performs one or more functions associated with the user device 102 (and/or a user of the user device 102, etc.), organization system 108, and/or the like. For example, computing device 126 can include a user identification verification system and/or module that stores user information and/or device information (e.g., identifiers, credentials, communication logs/data, etc.). The user information and/or device information may be used to verify the identity of the user device 102 and/or a user of the user device 102 to facilitate, enable, authenticate, and/or authorize the user device 102 and/or a user of the user device 102 for communication with the organization system 108.

For example, according to some aspects of this disclosure, the computing device 126 may be used in conjunction with authentication of a user of a mobile application running on the user device 102. For example, computing device 126 may be associated with a certification authority (CA) that certifies communications between devices in system 100 (e.g., the user device 102 and the organization system 108). According to some aspects of this disclosure, computing device 126 includes a server hosted by the organization system 108. According to some aspects of this disclosure, the computing device 126 may be a server hosted by a party or entity other than the organization system 108. According to some aspects of this disclosure, the computing device 126 may use knowledge-based authentication techniques, two-factor authentication techniques, credit bureau-based authentication techniques, database analysis, online verification (e.g., artificial intelligence, biometrics, computer vision, etc.) techniques, and/or any other techniques (or protocols) to verify the identity of a user of the user device 102 (e.g., a user of an application configured with the user device 102, etc.).

According to some aspects of this disclosure, the merchant device 124 may receive and/or be affected by malicious attacks by nefarious actors and/or devices, for example, such as malicious attempts to obtain sensitive information and use the sensitive information for nefarious activities including user impersonation, fraud, currency laundering, and/or the like. For example, nefarious actors and/or devices may initiate online purchasing schemes where nefarious merchant devices set up fraudulent virtual stores and/or the like.

According to some aspects of this disclosure, the organization system 108 may facilitate, validate, secure, support, and/or enable transactions between the user device 102 and the merchant device 124. For example, the organization system 108 may facilitate, support include, and/or be a component of a business platform, a banking-as-a-service (BaaS) platform, a software-as-a-service (SaaS) platform, a financial technology (FinTech) platform, an infrastructure-as-a-service (IaaS) platform, a platform-as-a-service (PaaS) platform, and/or the like. The organization system 108 may facilitate, support, and/or include security applications/protocols, authentication services, authorization services, and/or the like.

According to some aspects of this disclosure, the organization system 108 (e.g., device/components of the organization system 108, etc.) may perform transaction analysis and/or the like to determine and/or identify whether a merchant device/system (e.g., the merchant device 124, etc.) is a risky/fraudulent merchant device, such as a merchant device operated by a nefarious actor.

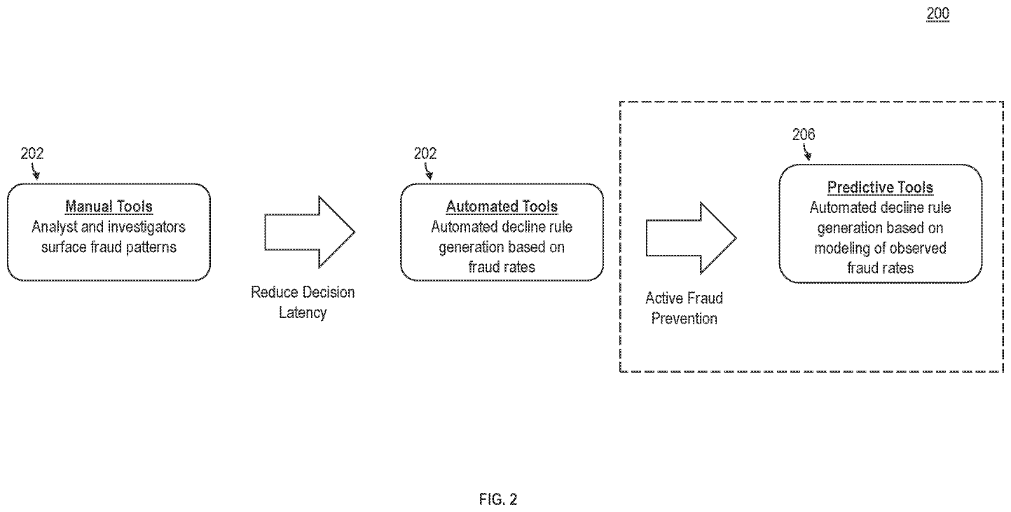

According to some aspects of this disclosure, and as further described later in reference to FIG. 2, the organization system 108 (e.g., a predictive (machine learning) model of an application server 120, etc.) may predict and/or forecast a likelihood of fraudulent activity associated with a merchant device and/or system by pre-classifying the merchant device and/or system as fraudulent or non-fraudulent. According to some aspects of this disclosure, the organization system 108 may include devices, components, and/or systems that may block a transaction between a user device (e.g., user device 102, etc.) and a merchant device (e.g., the merchant device 124, etc.) based on a classification of the merchant device. For example, the organization system 108 may block a transaction between a user device (e.g., user device 102, etc.) and a merchant device (e.g., the merchant device 124, etc.) if the merchant device is determined to be and/or classified as a fraudulent merchant device, a high-risk merchant device (e.g., likely fraudulent, etc.), and/or the like.

According to some aspects of this disclosure, the organization system 108 may classify a merchant (or any other entity) device, system, and/or component, for example, in real-time as opposed to conventional systems that, at best, identify fraudulent activity and/or nefarious actions associated with transactions and/or the like after (often significantly later) the activities and/or actions have occurred. The organization system 108 may classify a merchant (or any other entity) device, system, and/or component in real-time to prevent the organization system 108 from absorbing costs associated with fraudulent merchant devices, systems, and/or components. The organization system 108 may classify a merchant (or any other entity) device, system, and/or component in real-time to prevent damaging a user experience based on having to disassociate a fraudulent transaction from a user account.

According to some aspects of this disclosure, the organization system 108 may include and/or be associated with an entity, for example, such as a business, a corporation, an individual, a partnership, or any other entity that provides one or more goods, services, and/or consultations to individuals such as users. For example, the organization system 108 may include and/or be associated with a bank and/or a financial institution that facilitates transactions between a user and a merchant. According to some aspects of this disclosure, the organization system 108 may include one or more servers and computer systems for performing one or more functions associated with products and/or services that the organization system 108 provides. For example, according to some aspects of this disclosure, the organization system 108 may include a web server 110, a location services server 112, an application server 120, and/or a transaction server 114, as well as any other computer systems necessary to accomplish tasks associated with organization system 108 or the needs of users. It can be appreciated that application server 120, alone, or in combination with other servers in organization system 108 may perform the fraud detection described herein. According to some aspects of this disclosure, application server 120 may be configured to generate data sets that are used to train a machine learning model to generate graph embeddings for navigating graph representations of customers and merchant transactions. According to some aspects of this disclosure, application server 120 may navigate the graph representations to determine, in real-time, fraudulent activities/merchants, as well as predict other fraudulent merchants based on their location and proximity to the detected merchant within the graph representations.

According to some aspects of this disclosure, web server 110 may facilitate access to and/or generate websites accessible to customers and/or any other user/individuals involved in normal operations organization system 108, for example, via a device such as user device 102 and/or the like. According to some aspects of this disclosure, the web server 110 may include a computer system and/or communication module that enables/facilitates communications between the user device 102, for example, via an application (e.g., a mobile application, etc.), a user interface, a chat program, an instant messaging program, a voice-to-text program, an SMS message, email, or any other type or format of written or electronic communication. According to some aspects of this disclosure, the web server 110 may include one or more processors 132 and one or more databases 134 (e.g., any suitable repository of website data, etc.). Information stored in web server 110 may be accessed (e.g., retrieved, updated, and added to) via local network 116 and/or network 106 by devices and/or components of the system 100.

According to some aspects of this disclosure, web server 110 may host websites, data or software applications that user device 102 may access and interact with. For example, web server 110 may provide a website, web portal, and/or software application that allows a user of user device 102 to access or view account information associated with one or more financial accounts of the user. According to some aspects of this disclosure, web server 110 may generate and/or store a list of nefarious actors, for example, such as identified malicious and/or fraudulent merchant websites. According to some aspects of this disclosure, web server 110 may enable application server 120, for example, to access the detected list and utilize it as an initial training data set. According to some aspects of this disclosure, detected transactions that are deemed to be in close proximity to the detected fraudulent merchants may then be flagged as potential fraudulent merchants. It can be appreciated that the list of detected merchants may include merchants previously flagged as being fraudulent.

According to some aspects of this disclosure, web server 110 may receive and forward communications or portions of communications between user device 102 and components of system 100, such as location services server 112, transaction server 114, database 118, and/or application server 120. According to some aspects of this disclosure, web server 110 may be configured to transmit data and/or messages from user device 102 to organization system 108, for example, via a mobile application that has been downloaded on user device 102.

According to some aspects of this disclosure, web server 110 may track and store event data regarding interactions between user device 102 associated with a user and organization system 108. For example, web server 110 may track user interactions such as login requests, login attempts, successful logins, trusted device requests, updates to budget categories, updates to user accounts, and any other types of interaction that may occur between user device 102 and organization system 108.

According to some aspects of this disclosure, location services server 112 may include a computer system configured to track the location of user device 102 based on information and data received from user device 102. For example, location services server 112 may receive location data from user device 102, such as global positioning satellite (GPS) data comprising the coordinates of the device, RFID data associated with known objects and/or locations, or network data such as the identification, location, and/or signal strength of a wireless base station (e.g., Wi-Fi router, cell tower, etc.) connected to user device 102 that may be used to determine the location of user device 102.

According to some aspects of this disclosure, location services server 112 may store geofencing information that represents a designated location or area. As those of skill in the art will appreciate, a geofence may be a virtual geographic boundary that when crossed by user device 102, may trigger system 100 to execute one or more actions. According to some aspects of this disclosure, the contours of a geofence may be predetermined, for example, location services server 112 may receive one or more predetermined geofences that are associated with respective locations from a third party. For example, location services server 112 may receive data representative of a geofence around a particular store from an organization associated with the store that determined the location of the geofence. In some aspects of this disclosure, the contours of a geofence may be determined by receiving (e.g., from a user of system 100) the location of a point (e.g., longitude and latitude) and a radius and setting the contours of the geofence to be equal to the location of a circle drawn around the point at the specified radius. In some aspects of this disclosure, a geofence may be specified by a user of system 100 by, for example, drawing the geofencing onto a virtual map or otherwise inputting the location of the geofence. It can be appreciated that geofencing parameters may include parameters associated with a different country. For example, user device 102 may be detected as being in another country where more malicious transactions may occur. Based on that, organization system 108 may determine, using application server 120, for example, to heighten monitoring of financial transactions involving the user's account until a different location is detected.

According to some aspects of this disclosure, location services server 112 may have one or more processors 142 and one or more location services databases 144, which may be any suitable repository of location data. Information stored in location services server 112 may be accessed (e.g., retrieved, updated, and added to) via local network 116 and/or network 106 by one or more devices of system 100. In some aspects of this disclosure, location services server processor 142 may be used to determine the location of user device 102, whether user device 102 has crossed a particular geofence, or whether user device 102 is inside or outside of an area designated by a particular geofence. In some aspects of this disclosure, location services server 112 may be configured to send messages and/or data to other devices, for example, user device 102 or application server 120, upon determining that user device 102 has crossed a specified geofence or entered an area encompassed by a specified geofence. For example, in some aspects of this disclosure, location services server 112 may be configured to trigger system 100 to send to user device 102 a notification that one or more detected merchants/entities may be associated with suspicious activities, as discussed further herein.

According to some aspects of this disclosure, location services server 112 may receive data representative of a location that is associated with a merchant. For example, application server 120 may provide data to location services server 112 that represents a location of a particular store that is associated with a particular merchant. Location services server 112 may generate, receive, or access geofence information associated with the received location and may monitor location data associated with the user device 102 to determine when the user device 102 has entered the location. Based on the results, location services server 112 may determine that the merchant is fraudulent in cases where the merchant location and geofence location of device 102 do not match.

According to some aspects of this disclosure, transaction server 114 may include a computer system configured to process one or more transactions involving a financial account associated with a customer. For example, a transaction may be a purchase of goods or services from a merchant that is made in association with a financial account, such as a bank account or a credit card account. Transactions may be initiated at merchant 124 by for example making a payment using financial account information stored on a smartphone and/or in a digital wallet. Such transactions may be made at merchant locations or a merchant website via the internet.

According to some aspects of this disclosure, transactions may be made using, for example, a credit card, a debit card, a gift card, or other ways of conveying financial account numbers and/or account credentials that are known in the art. Transaction server 114 may have one or more processors 152 and one or more transaction server database 154, which may be any suitable repository of transaction data. Information stored in transaction server 114 may be accessed (e.g., retrieved, updated, and added to) via local network 116 and/or network 106 by one or more devices of system 100. According to some aspects of this disclosure, transaction server 114 may store account numbers, such as primary account numbers (PANs) associated with credit/debit cards or other such financial account numbers, that may be used in transaction monitoring as described in greater detail below. In some aspects of this disclosure, transaction server 114 may store rules, conditions, restrictions, or other such limitations that are associated with fraud detection and/or flags set by, for example, application server 120. Such flags may include labeling a merchant as a high-risk merchant and/or blocking such a high-risk merchant when a transaction is detected. It can be appreciated that the geofence information may be included in transaction information received at transaction server 114. As such, transaction server 114 may be configured to provide the geofence information to application server 120 for further processing/detection of fraudulent merchants.

Local network 116 may comprise any type of computer networking arrangement used to exchange data in a localized area, such as WiFi, Bluetooth™ Ethernet, and other suitable network connections that enable components of organization system 108 to interact with one another and to connect to network 106 for interacting with components in system 100. According to some aspects of this disclosure, local network 116 may comprise an interface for communicating with or linking to network 106. According to some aspects of this disclosure, components of organization system 108 may communicate via network 106, without a separate local network 116.

According to some aspects of this disclosure, application server 120 may comprise one or more computer systems configured to compile data from a plurality of sources, such as location server 110, communication server 112, and transaction server 114, correlate and analyze the compiled data in real-time (continuously), arrange the compiled data, generate derived data based on the compiled data, and store the compiled and derived in a database such as database 118. According to some aspects of this disclosure, application server 120 may perform merchant detection and prediction operations, for example, via a trained machine learning (ML) model 122 included with the application server 120. Example merchant detection and prediction operations performed by application server 120 (e.g., the ML model 122, etc.) are further described herein with reference to FIGS. 2-6.

According to some aspects of this disclosure, application server 120 may be used to manage user information and accounts associated with the user, provide analysis of the user data, and provide solutions based on modeled user behavior, merchant behavior, merchant categorization, and/or the like. According to some aspects of this disclosure, application server 120 (e.g., the ML model 122, etc.) may generate and/or provide recommendations to the user and/or user device (e.g., the user device 102, etc.) in real-time (at time of purchase for example) or on-demand (during a review of a profile and/or purchase history, etc.). According to some aspects of this disclosure, solutions based on modeled user behavior, merchant behavior, merchant categorization, and/or the like may include institutional recommendations (e.g., operators of organization system 108) or classification of one or more merchants in database 118.

According to some aspects of this disclosure, application server 120 may retrieve and analyze entity embeddings and their labels for use in downstream applications performed by the ML module 122, for example, such as fraud detection and/or the like. This, in turn, enables organization system 108 to not only detect outlier entities/activities (e.g., merchants/transactions) in real-time, but also predict similar entities/activities based on graph embeddings and analysis as further described herein.

According to some aspects of this disclosure, application server 120 may be a single server or may be configured as a distributed computer system including multiple servers or computers that interoperate to perform one or more of the processes and functionalities associated with the disclosed examples. Although the preceding description describes various functions of web server 110, location services server 112, transaction server 114, application server 120, computing device 126, database 118, in some aspects of this disclosure, some or all of these functions may be carried out by a single computing device.

FIGS. 2-6 describe example methods of generating labeled data sets, performing a nearest neighbor search, and performing downstream fraud detection, according to some aspects of this disclosure. For ease of discussion, examples may be described in connection with real-time processing, detection, and prediction of outlier entities that may not be approved to transact with a consumer/client of organization system 108. It is to be understood, however, that disclosed examples may be used in many other contexts. Further, steps or processes disclosed herein are not limited to being performed in the order described, but may be performed in any order, and some steps may be omitted, consistent with the disclosed examples.

FIG. 2 illustrates methods 200 for proactively preventing fraudulent activities, according to some aspects of this disclosure. According to some aspects of this disclosure, method 200 may include using manual tools 202 by analysts and investigators to identify fraud patterns. This may typically be performed on existing transactional data stored, e.g., in organization system 108. According to some aspects, in an attempt to reduce decision latency, automated tools may be used 204 that can be used to generate automated decline rules based on fraud rates. As discussed herein, such tools continue to rely on legacy data (e.g., transactions that have already occurred). In this manner, any merchant associated with the legacy data may then be identified and associated with the fraudulent activity and blocked accordingly. However, this may still be a time-consuming affair and latency still exists because going back in time to review previous transactions is a time-consuming affair. To further reduce latency, methods 200 may also proactively prevent fraudulent activities by predicting 206 behaviors of merchants based on a generated model for observed fraud. It can be appreciated that common transactions between a consumer and a plurality of merchants, classification of merchants can be possible, as will be further described below.

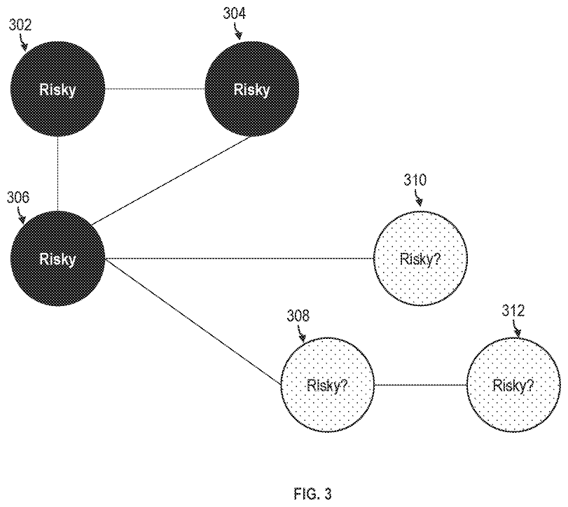

FIG. 3 illustrates an example graph diagram of merchant relationships. In the diagram, merchant systems may be represented by nodes of the graph, with edges between the nodes illustrating their ties (if any). As shown, the graph provides a visual representation of how similarities between merchants (or any other entity) may be detected and/or identified, according to some aspects of this disclosure.

According to some aspects of this disclosure, merchants (e.g., merchant systems, merchant devices, etc.) 302, 304, and 306 may be previously detected and/or identified merchant systems (and/or devices) and classified as “risky” merchants. This may be due to a previous detection of fraudulent activity associated with each of these merchants, and a manual or automated designation as risky merchants. According to some aspects of this disclosure, instead of waiting for additional fraudulent or risky transactions to occur, organization system 108 may deploy the systems and methodologies described herein to predict the behavior of other merchants based on their proximity to the risky merchants. This can enable organization system 108 to classify merchants and future transactions well before the transactions occur, and can thereby avoid lost time tracking fraudulent activities after the fact. For example, such merchants may be merchants 308, 310, and 312.

According to some aspects of this disclosure, merchants 308, 310, and 312 may be classified before the occurrence of any transaction involving organization system 108 or may be classified in real-time based on pending transactions. For example, upon detecting a requested transaction, transaction server 114 may consult database 118 to retrieve classification for a merchant (e.g., merchant 308) to determine whether to approve the transaction or not. If no record exists for merchant 308, the transaction server 114 may request application server 120 to perform an analysis to classify the merchant. This may be done in real-time or near real-time fashion. According to some aspects of this disclosure, whether an analysis is performed in real-time may be determined based on the significance of the transaction. For example, if the transaction amount is above a certain threshold value (e.g., above $5000, etc.), application server 120 (e.g., ML model 122, etc.) may perform the analysis in real-time before approving the transaction. Conversely, if the transaction amount is much lower (e.g., $10), then application server 120 (e.g., ML model 122, etc.) may perform the analysis in near real-time after initially approving the transaction. In this manner, small transactions that would not significantly affect organization system 108 may be approved to maximize user experience while also performing an analysis of the merchant. In this regard, given the reduced risk of exposure for organization system 108, a fraudulent merchant can still be detected in real-time while also ensuring the customer does not experience an undue delay in the transaction.

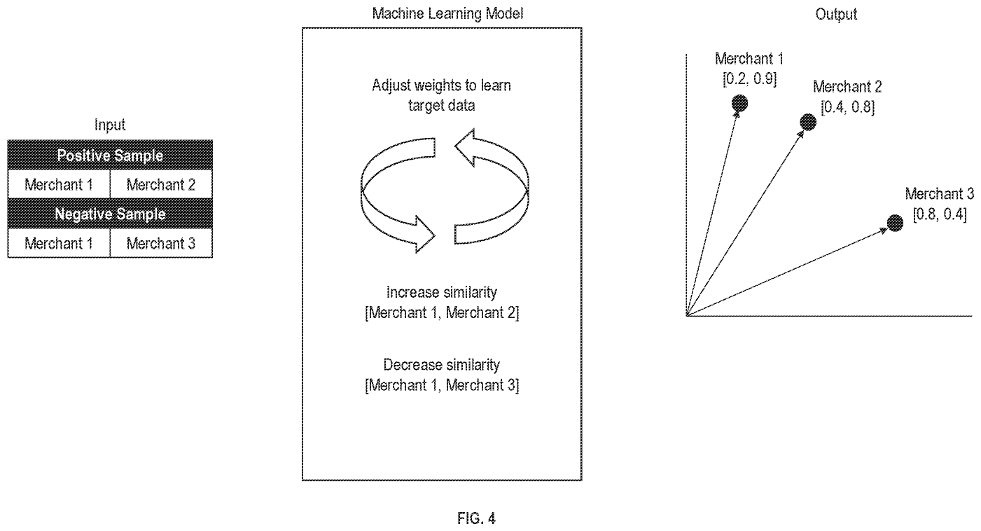

FIG. 4 illustrates an input and output representation for leveraging embeddings (e.g., embedding analysis for entity classification), according to some aspects of this disclosure. According to some aspects, in reference to natural language processing (NLP), a word embedding is a term used for the representation of words for text analysis, typically in the form of a real-valued vector that encodes the meaning of the word such that the words that are closer in the vector space are expected to be similar in meaning. FIG. 4 illustrates methodologies whereby positive and negative samples of merchant associates are used as input to a neural network to generate an output vector graph. A positive sample may be one where merchants are deemed sufficiently proximate in a transaction space, thereby requiring further analysis. A negative sample may be one where merchants are deemed insufficiently proximate in a transaction space, thereby not requiring further analysis. For example, an association between Merchant 1 and Merchant 2 may be detected. If a consumer transacts at Merchant 1 and within a short period of time transacts at Merchant 2, it can be determined that Merchant 1 and Merchant 2 have a positive association (e.g., deemed sufficiently proximate for further analysis). In the example illustrated in FIG. 4, Merchant 1 and Merchant 2 have a positive association and Merchant 1 and Merchant 3 have a negative association. It can be appreciated that other types of word embeddings may be used to achieve the intended objective of classifying the merchants. In one example, embeddings may be used to connect merchants experiencing high fraud rates to other merchants that have customers in common. This enables organization system 108 to identify the most similar merchant pairs that have positive or negative associations.

According to some aspects, when a table of positive and negative associations of merchants is generated, the table may be used as an input to a machine learning model using a neural network. For example, a support vector machine (SVM), random-forest, K means clustering, a multi-layer neural network with back-propagation, or other algorithms may be used with several associating factors to adjust weights and learn target data within the tables.

One example of training is the SVM, where features having the smallest weights are removed and the algorithm is re-trained with the remaining weights, wherein the process is repeated until features remain that are able to accurately separate the data into different patterns or classes. In this manner, a multi-dimensional separating hyperplane may be constructed. Alternately, a neural network type algorithm is used, such as a back-propagation neural network, where there may be a weight matrix for each layer of the neural network, wherein for each layer, a bias vector is defined. The model may first undergo forward propagation. In forward propagation, the input signals may be multiplied by the weights in the weight matrices for each layer, and activation functions may transform the output at each layer, wherein the end output may be calculated. Back propagation aids in computing the error of partial derivatives, which can then be minimized across layers and can form the central mechanism by which the neural network learns. This may aid in discovering trends for classification wherein resources of a particular input may be more likely to be used. Such trends may correspond to increasing similarities between close merchants (e.g., Merchant 1 and Merchant 2) and decreasing similarities between distant merchants (e.g., Merchant 1 and Merchant 3). A vector graph may be generated as an output representing a mapping of the merchants whereby Merchant 1 and Merchant 2 are closely related (due to similarities in transactions, users, etc.), and Merchant 1 and Merchant 3 are distantly related.

According to some aspects, the model may be trained on a link prediction task. That is, given a merchant pair (e.g., Merchant 1 and Merchant 2), the model may be trained to predict whether this pair has at least one account in common. In this regard, the model produces embeddings that encode accounts in common between merchants—thereby allowing organization system 108 to link merchants to detect fraudulent patterns.

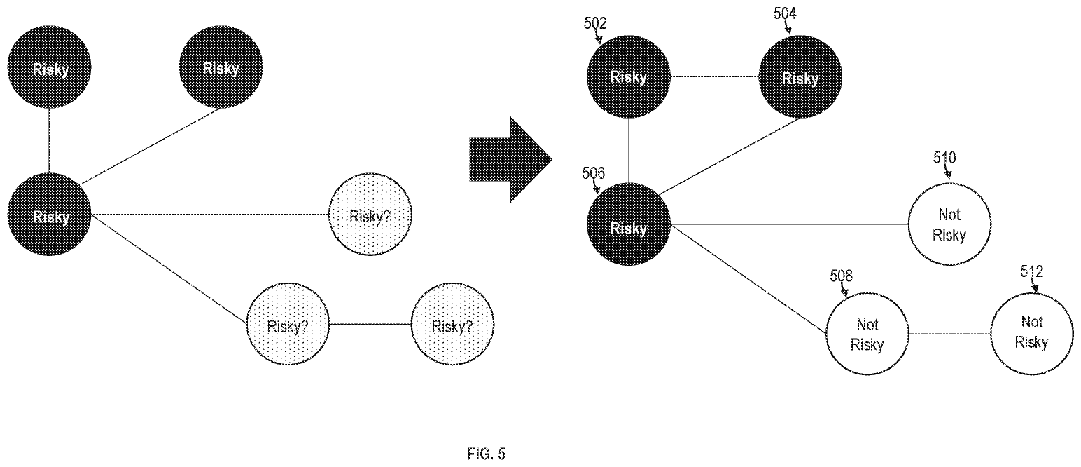

FIG. 5 illustrates a node representation of similar merchants and classification based on detected similarities, according to some aspects of this disclosure. In some aspects, based on the vector graph described with respect to FIG. 4, a merchant sufficiently close to risky merchants 502, 504, and 506 (e.g., merchant 508) may be classified as a risky merchant. Similarly, merchants that are not sufficiently close to the risky merchants (e.g., merchant 510 and merchant 512) may be classified as not risky.

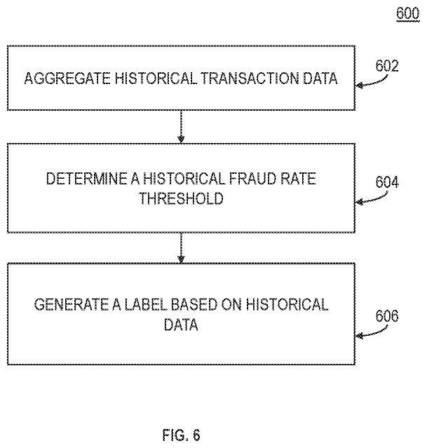

According to some aspects of this disclosure, FIG. 6 illustrates a method 600 for generating data labels that may be used to seed nearest neighbor search. At 602, method 600 may include aggregating historical financial transaction data involving merchants and consumer accounts. As noted herein, for example, application server 120 may retrieve such data aggregated by transaction server 114. The aggregating may also include capturing historical data reported by consumers and agents of organization system 108. According to some aspects of this disclosure, application server 120 may collect any/all historical data associated with the merchant(s) that have been reported by consumers or flagged by agents of the organization. For example, in a situation/scenario where application server 120 (or any other device/component of the system 100) stores consumer feedback flagging and/or indicating=a transaction with a merchant as suspicious, fraudulent, and/or the like, the stored customer feedback may be considered by application server 120 (e.g., the ML model 122, etc.). Similarly, server 120 may also take into account any agent-related inputs associated with a merchant.

At step 604, a threshold, for example, a historical fraud rate threshold and/or the like may be generated and/or determined. According to some aspects of this disclosure, how effectively the nearest neighbor search can identify fraudulent activities may correlate to how effectively a dataset used to train the ML model 122 is executed. For example, based on the quality of labeling used for a dataset, the downstream task of identifying similar (fraudulent) merchants will be more performant. According to some aspects of this disclosure, the ML model 122 may be trained in a dataset that includes labels for fraudulent merchants, potentially risky (e.g. high risk) merchants, non-fraudulent merchants, and/or any other type of classification based on aggregations of historical data, such as historical transactions and fraud reported thereupon.

According to some aspects of this disclosure, the ML model 122 may be trained to weigh the pros and cons of managing fraudulent transactions in view of optimizing user experiences. For example, according to some aspects of this disclosure, different thresholds are assigned to different degrees of potential fraud classification, and the ML model 122 is trained accordingly. For example, according to some aspects of this disclosure, the ML model 122 may be trained to classify a merchant that has 5% of all transactions reported as a fraud as a potentially risky merchant (e.g., high risk). The ML model 122 may classify a merchant that has >10% of all transactions reported as fraud as a fraudulent merchant. The ML model 122 may classify a merchant that has <5% of all transactions reported as fraud as a non-fraudulent merchant. It can be appreciated that the above threshold settings are non-limiting examples of other thresholds that may be set based on business objectives, for example, of the organization system 108. The ML model 122 may be trained, as described herein, to classify any entity.

At step 606, method 600 may further include generating a label based on the historical data, inputs, and thresholds. These labels are based on the thresholds established in step 604 and are stored alongside the entities (e.g. merchants) for later use in the nearest neighbor search. According to some aspects of this disclosure, information such as embeddings describing fraudulent merchants may be used to seed a nearest neighbor search, acting as a query population, and the high-risk merchants will form the population to be searched, acting as the candidate population. The non-fraudulent population can be safely excluded from further analysis.

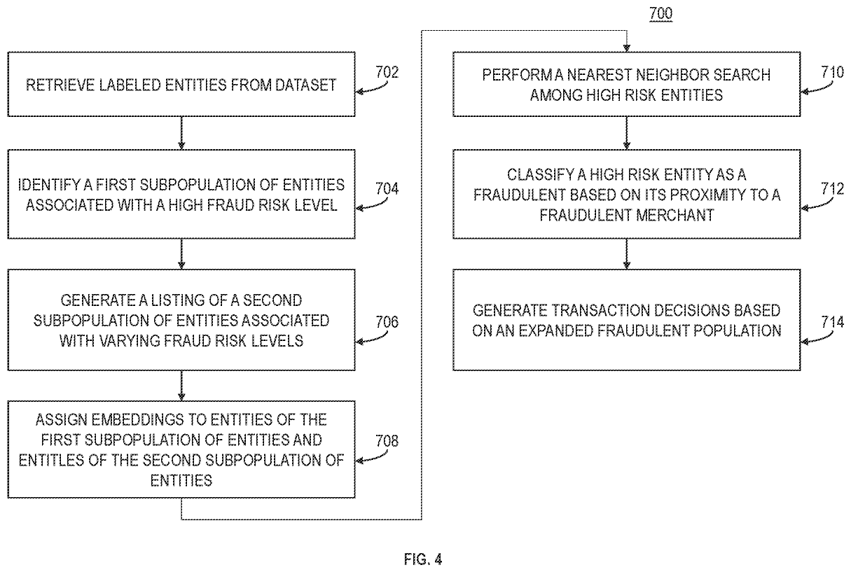

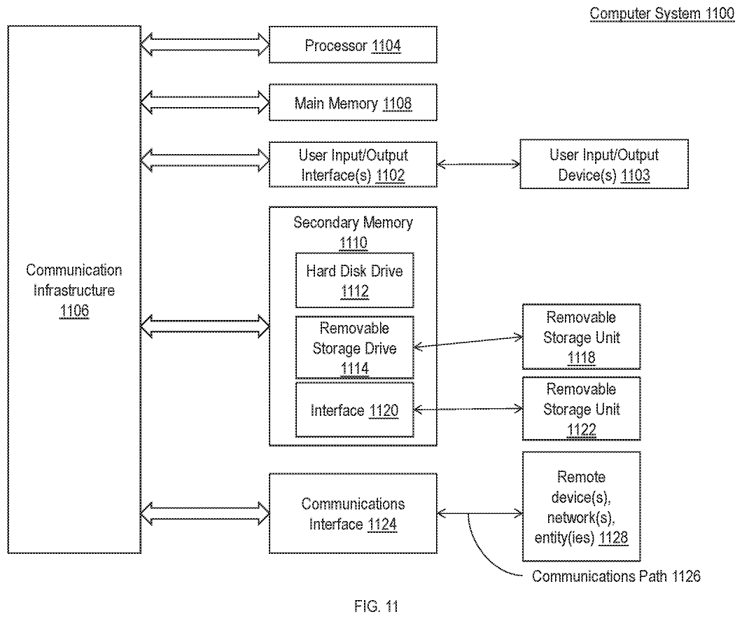

FIG. 7 shows an example computer-implemented method 700 for embedding analysis for entity classification, according to some aspects of this disclosure. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously, or in a different order than shown in FIG. 7, as will be understood by a person of ordinary skill in the art. Method 700 shall be described with regard to elements of FIGS. 1-6 and can be performed by a computing device (and/or a collection of computing devices), such as the application server 120 of FIG. 1 and/or the computer system of FIG. 11. However, method 700 is not limited to the specific aspects depicted in FIGS. 1-6 and other systems can be used to perform the method as will be understood by those skilled in the art.

According to some aspects, method 700 may facilitate downstream applications for fraud detection and monitoring utilizing embeddings (e.g., entity embeddings, word embeddings, etc.) learned from the financial transaction graph, along with the labels generated from historical fraud rates. The embeddings comprise latent representations of the merchants with respect to the graph of financial transactions among them. According to some aspects, method 700 is useful, for example, in further detecting potential fraudulent merchants that did not meet the threshold for classification at the time of data labeling based on the similarity of embeddings between high risk and fraudulent merchants.

At 702, method 400 may include querying or retrieving a database of entities with their associated fraudulent labels. For example, method 700 carried out by application server 120 may query a labeled data set that has been processed and stored in database 118. The data set may consist of multiple populations of entities, for example, fraudulent, high-risk, and not fraudulent merchants.

According to some aspects, at 704, method 700 may include identifying a first group of entities (e.g., merchants) that have a high fraud risk level. This may entail having application server 120 search and detect the respective label of each entity and identify the entities that are labeled as high-risk or risky entities.

At 706, method 700 may include generating a listing of a second subpopulation of entities having varying fraud risk levels. In one example, application server 120 may seek to identify merchants that may be associated with fraudulent transactions and have not yet been identified or tagged as such. As discussed herein, it is beneficial for organization system 108 to predict the behavior of risky merchants before reporting of fraudulent activities. This enables organization system 108 to prevent fraudulent transactions from occurring in the first place. According to some aspects, application server 120 may search and identify merchants that have safe merchant labels or low-risk labels, etc.

At 708, method 700 may include joining (or assigning) entities to their associated embeddings. For example, the previously learned entity embeddings may be stored in database 118 and identified by a key that will match them to the associated label determined by method 600.

At 710, method 700 carried out by application server 120 may perform a nearest neighbor search of fraudulent and high-risk entity embeddings. More specifically, taking a fraudulent merchant and a high-risk merchant into consideration, application server 120 may generate a similarity score between the fraudulent merchant and high-risk merchant. Similarity can be defined by, for example, a cosine similarity or other distance measures.

According to some aspects, at 712, the nearest neighbors of the fraudulent merchant may be deemed also fraudulent. The threshold for similarity that warrants a fraudulent label can be determined by business needs, taking into account the desire to prevent fraud as well as the tolerance for false identification. For example, application server 120 may perform a nearest neighbor search of the high-risk merchants to select those most proximal for further monitoring. At 714, the newly designated fraudulent merchants, as determined by proximity to previously identified fraudulent merchants via a nearest neighbor search of embeddings, can be used to monitor transactions and even automatically decline transactions at fraudulent merchants. This enables organization system 108 to monitor and predict future fraudulent transactions (by monitoring high-risk merchants) and assessing whether fraud is detected or not. According to some aspects of this disclosure, application server 120 may also output a notification to user device 102. The notification may include, for example, a notification that the transaction was not authorized due to merchant classification (e.g., fraudulent/high risk), a warning notification informing the user that the merchant previously transacted with is fraudulent, and that future transaction will not be authorized. By doing so, organization system 108 can maintain a high degree of satisfaction from the user experience standpoint because the user can be warned of potential threats, and be promptly notified that future transactions with this merchant will not be authorized. Rather than simply blocking a transaction and leaving the user guessing what the issue may be, this management aspect of the user experience by the systems of organization system 108 improves the user experience and helps with client retention.

According to some aspects, organization system 108 (e.g., through application server 120) may deploy decline rules for nearest neighbors that are identified as fraudulent. In one embodiment, application server 120 may generate a defensive mechanism that expands neighbor mapping and cataloging of predicted fraudulent and/or risky merchants. In this regard, the defensive mechanism may include blocking the pending transaction, sending the customer a push notification informing them of the decline and reasons for the decline, and placing the merchant in a risky merchant category.

According to some aspects, a non-fraudulent merchant that may be experiencing fraudulent activities due to, for example, a network hack, identity theft, and the like, may be deemed fraudulent even if they are not intentionally fraudulent. In this regard, application server 120 may also alert the merchant that fraudulent activity is detected and/or a strong fraudulent association is detected between the merchant and a risky merchant. Moreover, the application server 120 may also indicate that the identified merchant may be blocked from any further transactions for a predetermined period of time (e.g., 24 hours, 48 hours, 72 hours, etc.). Application server 120 may also place the merchant on a probationary category where the merchant needs to exhibit a sufficient number of non-fraudulent transactions. Application server 120 may determine this by performing a nearest neighbor search to determine if the merchant is still sufficiently close to risky merchants to be deemed risky or is now sufficiently distanced from such risky merchants.

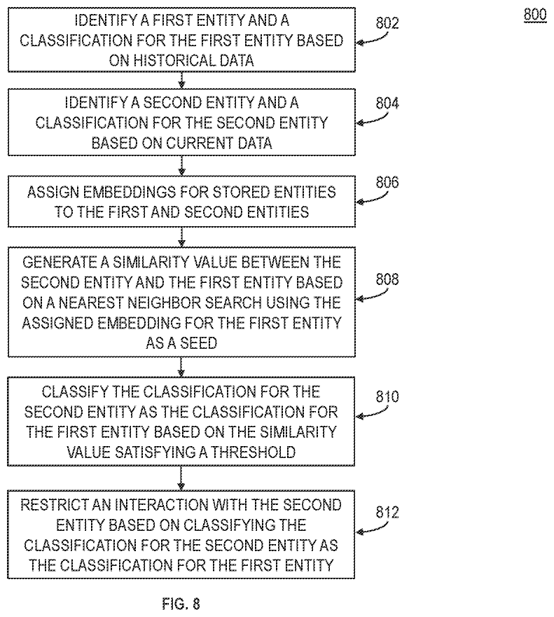

FIG. 8 shows an example computer-implemented method 800 for embedding analysis for entity classification, according to some aspects of this disclosure. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously, or in a different order than shown in FIG. 8, as will be understood by a person of ordinary skill in the art. Method 800 shall be described with regard to elements of FIGS. 1-6 and can be performed by a computing device (and/or a collection of computing devices), such as the application server 120 of FIG. 1 and/or the computer system of FIG. 11. However, method 800 is not limited to the specific aspects depicted in FIGS. 1-6 and other systems can be used to perform the method as will be understood by those skilled in the art.

In 802, application server 120 identifies a first entity and a classification for the first entity. For example, application server 120 identifies the first entity and the classification for the first entity based on historical data that indicates the first entity and the classification for the first entity. The classification for the first entity may be, for example, a “high-risk” classification.

In 804, application server 120 identifies a second entity and a classification for the second entity. For example, application server 120 identifies the second entity and the classification for the second entity based on current data that indicates the second entity and the classification for the second entity. The classification for the second entity may be different from the classification for the first entity. For example, the classification for the second entity may be a “low-risk” classification.

In 806, application server 120 assigns an embedding for a first stored entity to the first entity based on a match between the first entity and the first stored entity, and assigns an embedding for a second stored entity to the second entity based on a match between the second entity and the second stored entity.

In 808, application server 120 generates a similarity value between the second entity and the first entity. The application server 120 may generate the similarity value between the second entity and the first entity based on the assigned embedding for the first entity being a seed for a nearest-neighbor search.

In 810, application server 120 classifies the classification for the second entity as the classification for the first entity. The application server 120 may classify the classification for the second entity as the classification for the first entity based on the similarity value satisfying a threshold. For example, the second entity previously classified as “low-risk” may be classified as “high-risk” based on the similarity value satisfying a threshold.

In 812, application server 120 restricts an interaction with the second entity. The application server 120 may restrict the interaction with the second entity based on classifying the classification for the second entity as the classification for the first entity. The interaction with the second entity may include, for example, a transaction between the second entity and a user device, a request from the second entity to access a user account, an attempt by the second entity to access a network, and/or the like. Restricting the interaction with the second entity may include restricting the interaction for a predetermined period of time.

According to some aspects of this disclosure, method 800 may further include determining, based on at least one of the historical data or the current data input to a predictive model, the embedding for the first stored entity and the embedding for the second stored entity.

According to some aspects of this disclosure, method 800 may further include sending to a user device a request for credential information based on restricting the interaction with the second entity. The interaction with the second entity may be enabled based on receiving the credential information.

According to some aspects of this disclosure, method 800 may further include enabling an interaction with a third entity based on a similarity value between the third entity and the first entity being below the threshold. The similarity value between the third entity and the first entity may be generated based on the assigned embedding for the first entity being the seed for the nearest-neighbor search.

According to some aspects of this disclosure, the historical data further indicates a third entity, a classification for the third entity, and a geofence for the third entity. For example, the classification for the third entity may be a “low risk” classification and/or the like. The method 800 may further include determining, based on the historical data, the geofence for the third entity. Based on the current data, a user device attempting an interaction with the third entity at a location outside of the geofence may be determined. The interaction with the third entity at the location outside of the geofence may be restricted. Based on restricting the interaction with the third entity at the location outside of the geofence, the classification for the third entity may be classified as the classification for the first entity.

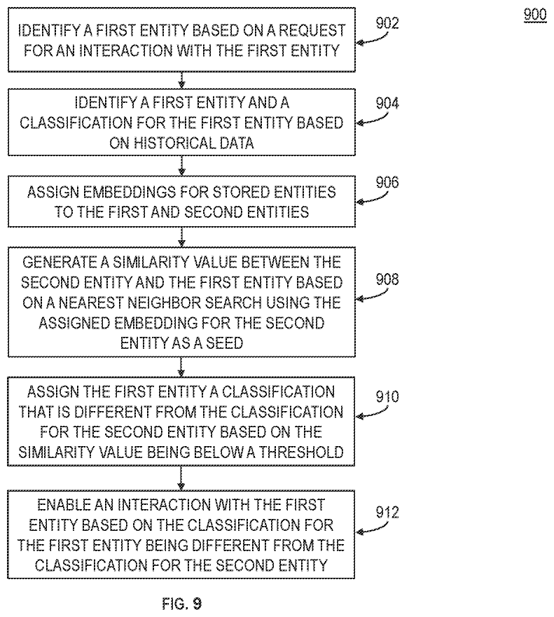

FIG. 9 shows an example computer-implemented method 900 for embedding analysis for entity classification, according to some aspects of this disclosure. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously, or in a different order than shown in FIG. 9, as will be understood by a person of ordinary skill in the art. Method 900 shall be described with regard to elements of FIGS. 1-6 and can be performed by a computing device (and/or a collection of computing devices), such as the application server 120 of FIG. 1 and/or the computer system of FIG. 11. However, method 900 is not limited to the specific aspects depicted in FIGS. 1-6 and other systems can be used to perform the method as will be understood by those skilled in the art.

In 902, application server 120 identifies a first entity. The application server 120 may identify the first entity based on a request for an interaction with the first entity.

In 904, application server 120 identifies, based on historical data that indicates a second entity and a classification for the second entity, the second entity and the classification for the second entity. For example, application server 120 may identify the second entity and the classification for the second entity based on historical data that indicates the second entity and the classification for the second entity. The classification for the second entity may be, for example, a “high-risk” classification and/or the like.

In 906, application server 120 assigns an embedding for a first stored entity to the first entity based on a match between the first entity and the first stored entity and an embedding for a second stored entity to the second entity based on a match between the second entity and the second stored entity.

In 908, application server 120 generates a similarity value between the second entity and the first entity. The application server 120 may generate the similarity value between the second entity and the first entity based on the assigned embedding for the second entity being a seed for a nearest-neighbor search.

In 910, application server 120 assigns a classification for the first entity that is different from the classification for the second entity. The application server 120 may assign a classification for the first entity that is different from the classification for the second entity based on the similarity value being below a threshold.

In 912, application server 120 enables an interaction with the first entity. The application server 120 may enable the interaction with the first entity based on the classification for the first entity being different from the classification for the second entity. The classification for the second entity may be, for example, a “low-risk” classification and/or the like. The interaction with the first entity may include a transaction between the first entity and a user device, a request from the first entity to access a user account, an attempt by the first entity to access a network, and/or the like. Enabling the interaction with the first entity may include enabling the interaction with the first entity for a predetermined period of time and/or the like.

According to some aspects of this disclosure, method 900 may further include determining, based at least in part on current data associated with the request for the interaction with the first entity and the historical data input to a predictive model, the embedding for the first stored entity and the embedding for the second stored entity.

According to some aspects of this disclosure, method 900 may further include restricting an interaction with the third entity. The interaction with the third entity may be restricted based on a similarity value between a third entity and the second entity satisfying the threshold. The similarity value between the third entity and the second entity may be generated based on the assigned embedding for the second entity being the seed for the nearest-neighbor search.

According to some aspects of this disclosure, the historical data further indicates a third entity, a classification for the third entity, and a geofence for the third entity. For example, the classification for the third entity may be a “low risk” classification and/or the like. The method 900 may further include determining, based on the historical data, the geofence for the third entity. Based on the current data, a user device attempting an interaction with the third entity at a location outside of the geofence may be determined. The interaction with the third entity at the location outside of the geofence may be restricted. Based on restricting the interaction with the third entity at the location outside of the geofence, the classification for the third entity may be classified as the classification for the first entity.

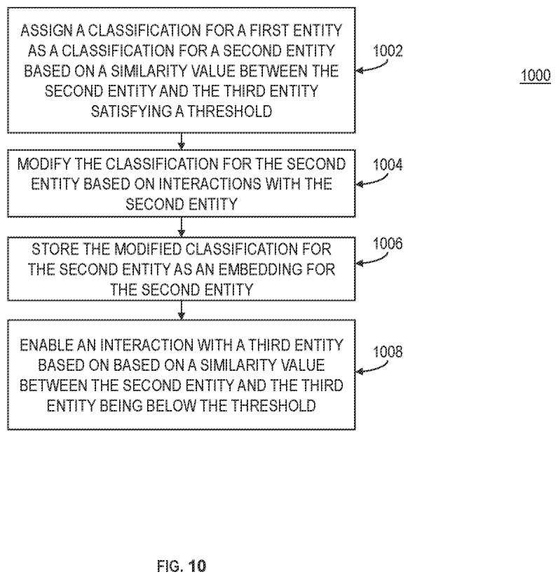

FIG. 10 shows an example computer-implemented method 1000 for embedding analysis for entity classification, according to some aspects of this disclosure. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously, or in a different order than shown in FIG. 10, as will be understood by a person of ordinary skill in the art. Method 1000 shall be described with regard to elements of FIGS. 1-6 and can be performed by a computing device (and/or a collection of computing devices), such as the application server 120 of FIG. 1 and/or the computer system of FIG. 11. However, method 1000 is not limited to the specific aspects depicted in FIGS. 1-6 and other systems can be used to perform the method as will be understood by those skilled in the art.

In 1002, application server 120 assigns a classification for the first entity as a classification for the second entity. The application server 120 may assign a classification for the first entity as a classification for the second entity based on a similarity value between the first entity and the second entity satisfying a threshold. The similarity value between the first entity and the second entity may be generated based on an embedding for a first entity being a seed for a nearest-neighbor search.

In 1004, application server 120 modifies the classification for the second entity. The application server 120 may modify the classification for the second entity based on additional data indicative of interactions with the second entity. The additional data indicative of interactions with the second entity may include indications of account login requests, network communications, account updates, transactions between the second entity and user devices, and/or the like.

In 1006, application server 120 stores an embedding for the second entity. The application server 120 may store an embedding for the second entity based on the modified classification for the second entity.

In 1008, application server 120 enables an interaction with the third entity. The application server 120 may enable interaction with the third entity based on a similarity value between the second entity and a third entity being below the threshold. The similarity value between the second entity and the third entity may be generated based on the embedding for the second entity being a seed for another nearest-neighbor search. The interaction with the third entity may include a transaction between the third entity and a user device, a request from the third entity to access a user account, an attempt by the third entity to access a network, and/or the like. Enabling the interaction with the third entity may include enabling the interaction with the third entity for a predetermined period of time.

According to some aspects of this disclosure, method 1000 may further include determining, based on historical data input to a predictive model, the embedding for the first stored entity.

According to some aspects of this disclosure, method 1000 may further include sending, to a user device a notification that the interaction with the third entity is enabled based on enabling the interaction with the third entity.

Various examples of the disclosure may be implemented, for example, using one or more well-known computer systems, such as computer system 1100 shown in FIG. 11. One or more computer systems 1100 may be used, for example, to implement any of the examples discussed herein, as well as combinations and sub-combinations thereof.

Computer system 1100 may include one or more processors (also called central processing units, or CPUs), such as a processor 1104. Processor 1104 may be connected to a communication infrastructure (and/or bus) 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random-access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, a tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities, or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects of this disclosure, a tangible, non-transitory apparatus or article of manufacture comprising a tangible, non-transitory computer usable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use examples of this disclosure using data processing devices, computer systems and/or computer architectures other than that shown in FIG. 11. In particular, examples can operate with software, hardware, and/or operating system examples other than those described herein.

Descriptions of an embodiment contemplate various combinations, components and sub-components. However, it will be understood that other combinations of the components and sub-components may be possible while still accomplishing the various aims of the present application. As such, the described examples are merely examples, of which there may be additional examples falling within the same scope of the disclosure.

What is claimed is:

1. A computer-implemented method for embedding analysis for entity classification, the method comprising:
identifying, based on historical data that indicates a first entity and a classification for the first entity, the first entity and the classification for the first entity;
identifying, based on current data that indicates a second entity and a classification for the second entity, the second entity and the classification for the second entity, wherein the classification for the second entity is different from the classification for the first entity;
assigning an embedding for a first stored entity to the first entity based on a match between the first entity and the first stored entity and an embedding for a second stored entity to the second entity based on a match between the second entity and the second stored entity;
generating, based on the assigned embedding for the first entity being a seed for a nearest-neighbor search, a similarity value between the second entity and the first entity;
classifying, based on the similarity value satisfying a threshold, the classification for the second entity as the classification for the first entity; and
restricting, based on the classifying the classification for the second entity as the classification for the first entity, an interaction with the second entity.

2. The computer-implemented method of claim 1, further comprising:
determining, based on at least one of the historical data or the current data input to a predictive model, the embedding for the first stored entity and the embedding for the second stored entity.

3. The computer-implemented method of claim 1, further comprising:
sending to a user device, based on restricting the interaction with the second entity, a request for credential information; and
enabling, based on receiving the credential information, the interaction with the second entity.

4. The computer-implemented method of claim 1, wherein the interaction with the second entity comprises at least one of: a transaction between the second entity and a user device, a request from the second entity to access a user account, or an attempt by the second entity to access a network.

5. The computer-implemented method of claim 1, wherein the restricting the interaction with the second entity comprises restricting the interaction with the second entity for a predetermined period of time.

6. The computer-implemented method of claim 1, further comprising:
enabling, based on a similarity value between a third entity and the first entity being below the threshold, an interaction with the third entity, wherein the similarity value between the third entity and the first entity is generated based on the assigned embedding for the first entity being the seed for the nearest-neighbor search.

7. The computer-implemented method of claim 1, wherein the historical data further indicates a third entity, a classification for the third entity, and a geofence for the third entity, the method further comprising:
determining, based on the historical data, the geofence for the third entity;
determining, based on the current data, a user device attempting an interaction with the third entity at a location outside of the geofence;
restricting the interaction with the third entity at the location outside of the geofence; and
classifying, based on the restricting the interaction with the third entity at the location outside of the geofence, the classification for the third entity as the classification for the first entity.

8. A computer-implemented method for embedding analysis for entity classification, the method comprising:
identifying, based on a request for an interaction with a first entity, the first entity;
identifying, based on historical data that indicates a second entity and a classification for the second entity, the second entity and the classification for the second entity;
assigning an embedding for a first stored entity to the first entity based on a match between the first entity and the first stored entity and an embedding for a second stored entity to the second entity based on a match between the second entity and the second stored entity;
generating, based on the assigned embedding for the second entity being a seed for a nearest-neighbor search, a similarity value between the second entity and the first entity;
assigning, based on the similarity value being below a threshold, a classification for the first entity that is different from the classification for the second entity; and
enabling, based on the classification for the first entity being different from the classification for the second entity, the interaction with the first entity.

9. The computer-implemented method of claim 8, further comprising:
determining, based at least in part on current data associated with the request for the interaction with the first entity and the historical data input to a predictive model, the embedding for the first stored entity and the embedding for the second stored entity.

10. The computer-implemented method of claim 8, wherein the interaction with the first entity comprises at least one of: a transaction between the first entity and a user device, a request from the first entity to access a user account, or an attempt by the first entity to access a network.

11. The computer-implemented method of claim 8, wherein the enabling the interaction with the first entity comprises enabling the interaction with the first entity for a predetermined period of time.

12. The computer-implemented method of claim 8, further comprising:
restricting, based on a similarity value between a third entity and the second entity satisfying the threshold, an interaction with the third entity, wherein the similarity value between the third entity and the second entity is generated based on the assigned embedding for the second entity being the seed for the nearest-neighbor search.

13. The computer-implemented method of claim 8, wherein the historical data further indicates a third entity, a classification for the third entity, and a geofence for the third entity, the method further comprising:
determining, based on the historical data, the geofence for the third entity;
determining, based on the current data, a user device attempting an interaction with the third entity at a location outside of the geofence;
restricting the interaction with the third entity at the location outside of the geofence; and
classifying, based on the restricting the interaction with the third entity at the location outside of the geofence, the classification for the third entity as the classification for the first entity.

14. The computer-implemented method of claim 8, wherein at least one of the first entity or the second entity comprises at least one of a merchant device, an enterprise system, or a network device.

15. A computer-implemented method for embedding analysis for entity classification, the method comprising:
assigning, based on a similarity value between a first entity and a second entity satisfying a threshold, a classification for the first entity as a classification for the second entity, wherein the similarity value between the first entity and the second entity is generated based on an embedding for a first entity being a seed for a nearest-neighbor search;
modifying, based on additional data indicative of interactions with the second entity, the classification for the second entity;
storing, based on the modified classification for the second entity, an embedding for the second entity;
enabling, based on a similarity value between the second entity and a third entity being below the threshold, an interaction with the third entity, wherein the similarity value between the second entity and the third entity is generated based on the embedding for the second entity being a seed for another nearest-neighbor search;

16. The computer-implemented method of claim 15, further comprising determining, based on historical data input to a predictive model, the embedding for the first stored entity.

17. The computer-implemented method of claim 15, further comprising sending, to a user device, based on enabling the interaction with the third entity, a notification that the interaction with the third entity is enabled.

18. The computer-implemented method of claim 15, wherein the interaction with the third entity comprises at least one of: a transaction between the third entity and a user device, a request from the third entity to access a user account, or an attempt by the third entity to access a network.

19. The computer-implemented method of claim 16, wherein the enabling the interaction with the third entity comprises enabling the interaction with the third entity for a predetermined period of time.

20. The computer-implemented method of claim 15, wherein the additional data indicative of interactions with the second entity comprises indications of at least one of account login requests, network communications, or account updates.
